(19) United States
(12) Patent Application Publication
(10) Pub. No.: US 2009/0241492 A1
(43) Pub. Date: Oct. 1, 2009

(54) TWO-STAGE DUST COLLECTOR

(75) Inventor: Kun-Yen LIN, Taichung City (TW)

Correspondence Address: Muncy, Geissler, Olds & Lowe, PLLC, P.O. BOX 1364, FAIRFAX, VA, 22038-1364, US

(73) Assignee: META INTERNATIONAL CO., LTD.

(21) Appl. No.: 12/055,897

(22) Filed: Mar. 26, 2008

(51) Int. Cl. B01D 51/00

(52) U.S. Cl. 55/418

(57) ABSTRACT

The present invention discloses a two-stage dust collector, which comprises: a separating device, an air suction pipe, and two interconnection devices. A motor is arranged above the separating device, and an air flow generator is arranged below the motor. The air suction pipe is arranged on the surface of the separating device. The separating device sucks in external air via the air suction pipe and casts off impurities into a dust collecting device arranged below the separating device. The ends of the two interconnection devices are respectively joined to two air flow outlets oppositely arranged in the air flow generator, and the other ends of the two interconnection devices are respectively joined to two filtration devices. Thereby, the two-stage dust collector having two air flow outlets can suck in and filter dust-containing air more rapidly.

### FIELD OF THE INVENTION

The present invention relates to a two-stage dust collector, particularly to a two-stage dust collector having two air flow outlets, which can filter more dust-containing air per unit time.

### BACKGROUND OF THE INVENTION

Dust collectors are usually equipped in the works generating dust and used to collect dust in the environment lest dust floats everywhere and pollutes the air. For example, when lumber is sawed into pieces or fabricated into a specified shape in a wood mill, a great amount of wood debris and wood dust is generated. The floating wood debris and wood dust will contaminate the air and harm the health of the workers inhaling the debris and dust. Therefore, wood mills generally have large-size dust collectors.

Refer to FIG. 1 and FIG. 2 for a conventional dust collector. The conventional two-stage dust collector has a separating device 1. A motor 2 is arranged above the separating device 1, and an air flow generator 3 having a plurality of blades 3a is arranged below the motor 2. An air suction pipe 4 is arranged on the surface of the separating device 1. The motor 2 drives the blades 3a of the air flow generator 3 to suck external air. The internal structure of the separating device 1 filters out impurities from air. The larger impurities will fall into a dust collecting device 5 arranged below the separating device 1. The dust collecting device 5 is used to collect wood debris, wood dust and general dust. Thus is completed the first stage of filtration and dust collection.

The air flow generated by the air flow generator 3 will pass through an interconnection device 6 to a filtration device 7. The filtration device 7 uses a meshed structure to filter out the dust in the air flow and then discharges the air flow. Thus is completed the second stage of filtration and dust collection. Besides, the filtration device 7 usually has a dust collecting device 8 therebelow to collect debris and dust. The collected debris and dust can be easily cleaned up via taking out the dust collecting device 8 and outpouring debris and dust thereinside.

However, only an air flow outlet 3b is used to discharge the air flow into the interconnection device 6. Thus, the air flow will not be discharged into the interconnection device 6 until the blade 3a has completed a full circle of rotation. Therefore, in addition to the friction and fan resistance, the air flow has a pretty long travel inside the air flow generator 3, which results in the inferior efficiency of the dust collector.

### SUMMARY OF THE INVENTION

The primary objective of the present invention is to provide a two-stage dust collector having two air flow outlets in addition to two filtration devices, whereby the detention time of the air flow is decreased, and the flow rate, flow speed, and pressure drop are increased, and a higher suction force is thus attained.

The present invention proposes a two-stage dust collector, which comprises: a separating device, an air suction pipe and two interconnection devices. A motor is arranged above the separating device, and an air flow generator is arranged below the motor. The air flow generator has two air flow outlets arranged oppositely. The air suction pipe is arranged on the surface of the separating device. The separating device sucks in external air via the air suction pipe and casts off impurities of air into a dust collecting device arranged below the separating device. The ends of the two interconnection devices are respectively connected with the two air flow outlets. Thus is formed a two-stage dust collector having two air flow outlets. Thereby, the air flow's travel to the outlet is shortened, and the influence of friction and fan resistance is reduced, and the efficiency of the duct collector is promoted.

In the present invention, two filtration devices are respectively connected with the other ends of the two interconnection devices. The filtration devices have meshed structures, which can physically block the particles in air and release the filtered air.

In the present invention, two dust collecting devices are further respectively arranged below the two filtration devices to collect tinier particles.

The present invention is characterized in the design of two air flow outlets arranged in the opposite sides of the air flow generator. The two air flow outlets can shorten the time that air stays in the air flow generator, raise the flow rate, and increase suction force. Thereby, the air flow is more rapidly led to the filtration devices for filtration and then discharged therefrom. Thus is promoted the efficiency of the dust collector.

### BRIEF DESCRIPTION OF THE DRAWINGS

FIG. 1 is a diagram schematically showing a conventional dust collector.

FIG. 2 is a diagram schematically showing an air flow outlet of a conventional dust collector.

FIG. 3 is a diagram schematically showing a two-stage dust collector according to the present invention.

FIG. 4 is a diagram schematically showing air flow outlets of a two-stage dust collector according to the present invention.

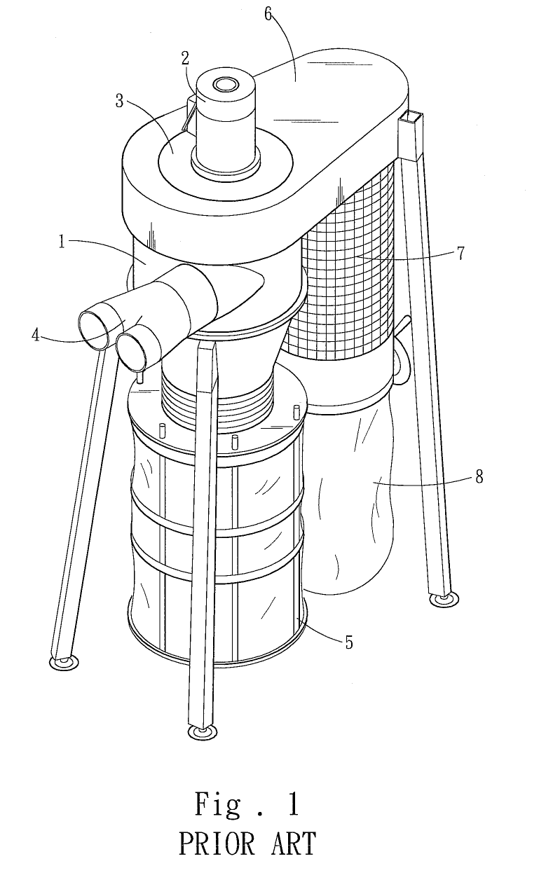

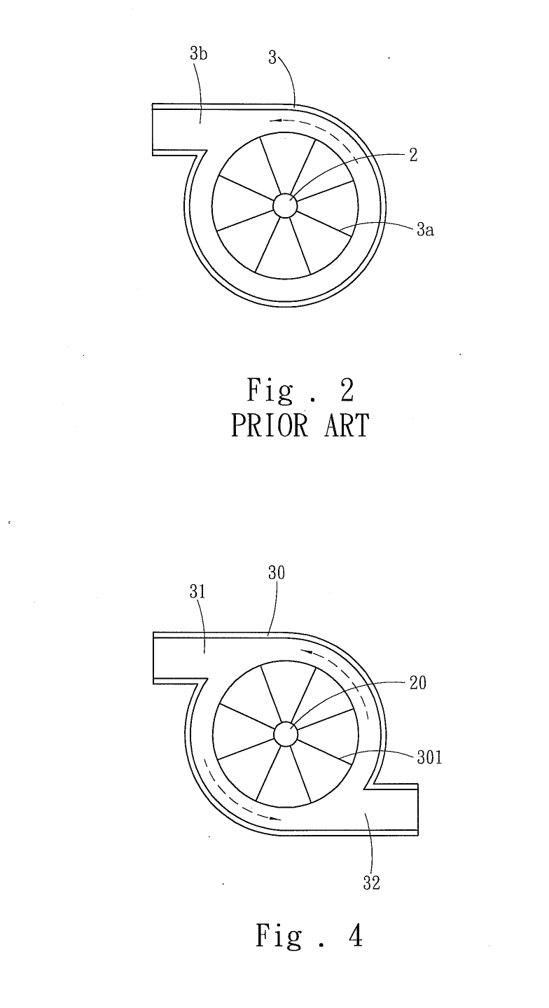

### DETAILED DESCRIPTION OF THE PREFERRED EMBODIMENTS

Below, the technical contents of the present invention are described in detail with embodiments. However, it should be understood that the embodiments are only to exemplify the present invention but not to limit the scope of the present invention.

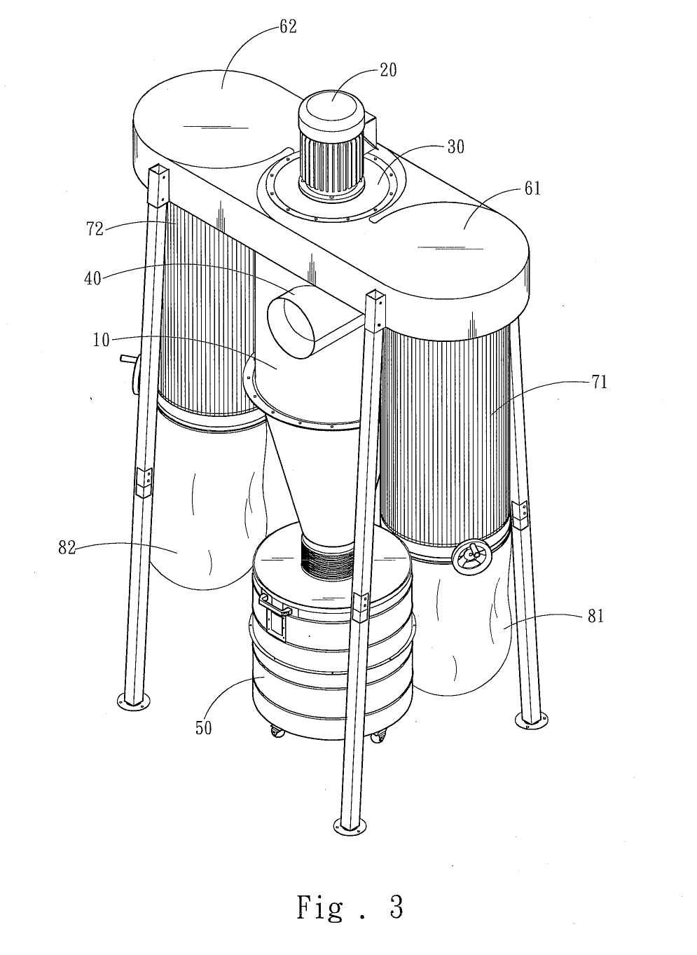

Refer to FIG. 3 and FIG. 4. According to the present invention, a two-stage dust collector comprises: a separating device 10, an air suction pipe 40, and two interconnection devices 61 and 62. The separating device 10 is used to separate debris and dust from the air sucked in by the dust collector. A motor 20 is arranged above the separating device 10, and an air flow generator 30 having a plurality of blades 301 is arranged below the motor 20. The air flow generator 30 also has two air flow outlets 31 and 32 arranged oppositely. The air suction pipe 40 is arranged on the surface of the separating device 10. The motor 20 drives the blades 301 of the air flow generator 30 to rotate and create pressure drop to suck external air into the separating device 10. The separating device 10 uses the internal structure thereof to filter out impurities of air and casts off the impurities into a dust collecting device 50 arranged below the separating device 10. The dust collecting device 50 is used to collect wood debris, wood dust and general dust. Thus is completed the first stage of filtration and dust collection.

The filtered air flow passes through the two air flow outlets 31 and 32 and enters the two interconnection devices 61 and 62, which are respectively joined to the two air flow outlets 31 and 32 from the ends thereof and guide the air flow coming from the air flow generator 30. Via the design of two air flow outlets 31 and 32, the air flow can be discharged from either of two air flow outlets 31 and 32 in only half a circle of rotation of the blades 301, which can shorten the travel of the air flow in the air flow generator 30, reduce the influence of friction and fan resistance, and decrease the time that air stays in the air flow generator 30. Thereby, a higher suction force and a greater flow rate are attained.

The other ends of the two interconnection devices 61 and 62 are respectively joined to two filtration devices 71 and 72. The filtration devices 71 and 72 have meshed structures, which can filter smells and block particles and then release the filtered air. Thus is completed the second stage of filtration and dust collection. The design of two air flow outlets 31 and 32 can shorten the time that air stays in the air flow generator 30, raise the flow rate, and increase suction force. Thereby, the air flow is more rapidly led to the filtration devices 71 and 72 for filtration and then discharged therefrom. Thus is promoted the efficiency of the dust collector.

Further, two dust collecting devices 81 and 82 may be respectively arranged below the two filtration devices 71 and 72 to collect tinier particles.

The preferred embodiments described above are only to exemplify the present invention but not to limit the scope of the present invention. Therefore, any equivalent modification or variation according to the spirit of the present invention is to be also included within the scope of the present invention.

What is claimed is:

1. A two-stage dust collector, comprising:
a separating device, wherein a motor is arranged above said separating device, and an air flow generator is arranged below said motor, and said air flow generator has two air flow outlets arranged oppositely;
an air suction pipe, arranged on a surface of said separating device, wherein said separating device sucks in external air via said air suction pipe and casts off impurities into a dust collecting device arranged below said separating device; and
two interconnection devices, wherein said two air flow outlets are respectively joined to the ends of said two interconnection devices, and two filtration devices are respectively joined to the other ends of said two interconnection devices.

2. The two-stage dust collector according to claim 1, wherein two dust collecting devices are respectively arranged below said two filtration devices.
